(19) United States
(12) Patent Application Publication
(10) Pub. No.: US 2011/0155007 A1
(43) Pub. Date: Jun. 30, 2011

(54) PLATELESS TRANSFER PRINTING FILM, DEVICE WITH COLORED PATTERN AND THE METHOD OF MANUFACTURING THE SAME

(75) Inventor: Chung-Sheng LIU, Taipei (TW)

(73) Assignee: CLEVO CO., Taipei (TW)

(21) Appl. No.: 12/972,827

(22) Filed: Dec. 20, 2010

(30) Foreign Application Priority Data
Dec. 30, 2009 (TW) 98145823

(51) Int. Cl. B41L 47/02; B29C 59/02; B41M 9/04

(52) U.S. Cl. 101/368; 264/293; 427/147

(57) ABSTRACT

Disclosed is a device with colored pattern which is made by a plateless transfer printing technology. The device includes a body, an adhesive layer, a white ink layer and a pattern layer. The adhesive layer is formed on the body. The white ink layer is formed on the adhesive layer. The pattern layer is on the white ink layer. In particular, the pattern layer is customized to be a color ink layer which is printed with colored picture, character, symbol or number. In the manufacturing method of the device, a plateless transfer printing film is prepared to cover the body. Next, the film is transferred to the surface of the body, especially by a roller-embossing process. A blowing-embossing process is then applied to the plateless transfer printing film. Therefore, a fast and uniform transfer printing is achieved.

### BACKGROUND OF THE INVENTION

1. Field of the Invention

The instant disclosure relates to a transfer-printing technology, more particularly to the technology of plateless transfer printing which transfers pattern onto the casing of an electronic device.

2. Description of Related Art

Various transfer printing technologies are conventionally provided, such as water-transfer printing, heat-transfer printing and rubbing transfer printing. The pattern to be transferred may be acquired through the traditional printing or digital printing. The printing technologies may be selected from a general transfer printing and a plateless transfer printing. It is noted that the heat-transfer printing has been extensively applied to the various articles. The printing technologies make the article beautiful or/and unique.

The heat-transfer printing essentially allows a transfer film to cover over the surface of an article. Through the printing technology, a pattern can be transferred onto the article via a transfer film. In general, the transfer printing process is particularly applied to obtaining a stable quality over a small area or a plane. However, the conventional transfer printing process may still induce the blisters between the printing film and the article to be transferred, and therefore the film may be uneven and/or stripped off easily on a convex surface or over a vertical angle especially.

### SUMMARY OF THE INVENTION

It is featured in the instant disclosure that a method for manufacturing an electronic device with colored pattern is introduced to improving the conventional transfer printing process onto the uneven surface or vertical angle. The present method can particularly avoid the occurrence of uneven or un-adhesive between the printing film and the electronic device.

In view of the drawback of conventional transfer-printing, the method for manufacturing the device with evenly transfer-printed colored pattern is disclosed.

In particular, the transfer-printing scheme adopted in the invention is to provide a method for manufacturing a plateless transfer printing paper. A plastic film or a paper is preferably used to be a substrate firstly. Next, a release agent is coated on the substrate through a coating machine and a de-bonding layer is formed thereon. After drying the de-bonding layer, a transparent anti-dissolvent ink is coated onto the de-bonding layer for forming a transparent protective layer.

After that, a pattern layer is formed while outputting a colored picture through a laser printer or an ink-jet printer. In one embodiment, the pattern layer can be formed through a series of printing steps. When the pattern layer is dried, a white-color ink is printed on the pattern layer for forming a white ink layer as a color base. When the white ink layer is dried, heat-transfer printing glue is then coated on the white ink layer for forming an adhesive layer.

In one aspect for solving the mentioned drawbacks, the method for manufacturing the electronic device with colored transfer printing scheme is introduced. A plateless transfer printing film is firstly prepared. The body of electronic device is covered with the plateless transfer printing film. A roller is given to perform a roller-embossing process over the plateless transfer printing film. At last, a blowing and embossing process is applied to the plateless transfer printing film.

The mentioned roller is used to enhance sealing ability between the plateless transfer printing film and the electronic device. The roller may achieve a smooth transfer printing. Thus the transfer printing process in the method may acquire a good quality of printing.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a cross-sectional diagram of the plateless transfer printing film of the embodiment in accordance with the present disclosure;

FIG. 2 shows a schematic diagram of the plateless transfer printing film in accordance with the present disclosure;

FIG. 3 shows a schematic diagram of the electronic device with a colored pattern in one of the embodiments of the present disclosure;

FIG. 4 shows a schematic diagram of the plateless transfer printing device in accordance with the present disclosure;

FIG. 5 illustrates a flow chart of the manufacture method of the plateless transfer printing in accordance with the present disclosure; and

FIG. 6 illustrates a flow chart of the manufacture method of the electronic device with the colored pattern.

### DETAILED DESCRIPTION OF THE PREFERRED EMBODIMENTS

In an exemplary embodiment, the instant disclosure particularly incorporates a roller into performing a plateless transfer printing over an electronic device body. The plateless transfer printing film can be transferred onto the body evenly. Preferably it is a full-color pattern printed on the article.

In order to provide explanation in more detail, the following description is directed to the present disclosure in view of the schematic diagrams. The description also shows forth the advantages and any achievement by incorporating the technology and various means of the invention more definitely.

While some following descriptions mentioning a specific layer formed above another layer or the similar descriptive wordings regarding the relative positions, it's to point out the exemplary embodiment shown in the diagram. In a case if the coordinates rotates, the previous mentioned upper layer will be changed to the lower layer, and any possible layer may be existed there-between.

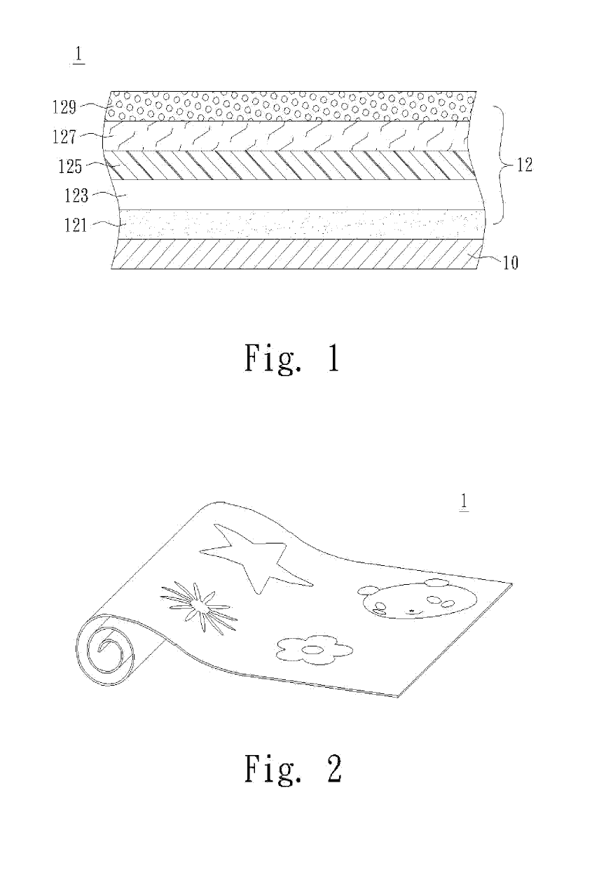

Reference is made to FIG. 1 showing a cross-sectional diagram of one embodiment of the plateless transfer printing film in accordance with the instant disclosure. A plateless transfer printing film 1 in the diagram mainly includes a substrate 10 and a transferring layer 12. The transferring layer 12 includes a de-bonding Layer 121, a transparent protective layer 123, a pattern layer 125, a white ink layer 127, and an adhesive layer 129.

The transferring layer 12 is formed above the substrate 10. The de-bonding Layer 121 is also above the substrate 10. Further, the transparent protective layer 123 is formed above the de-bonding Layer 121. The pattern layer 125 is above the transparent protective layer 123. Still further, the white ink layer 127 is formed above the pattern layer 125, and the adhesive layer 129 is then above the white ink layer 127.

The mentioned substrate 10 may be made of the flexible plate such as a plastic film or a paper like material. Since the plastic film may be easily coated with the ink, the de-bonding layer 121 is required to be added. This de-bonding layer 121 may be made of a heat fusing type, a heat-curing type or semi-hardening type release agent. The de-bonding layer 121 can be functioned as a release agent that is able to separate the pattern layer 125 from the substrate 10. The transparent protective layer 123 is characterized as a heat-proof and difficult-to-melt material such as a transparent anti-dissolvent ink, transparent acrylic glue, or transparent hot-melt glue. Not only the transparent protective layer is provided for the printer successfully outputting the pattern layer 125, but also protecting the pattern layer 125 from erosion of chemical solvent or any physical abrasion.

In an exemplary embodiment, the pattern layer 125 is as the color ink layer output with utilization of a laser printer or an inkjet printer. The ink, for forming one or in combination of the picture, character, symbol and number, is preferably an environmental friendly solvent ink. The pattern layer 125 may exemplarily be completed by repeating four times of coating with four colors and drying process. The four colors are preferably the primitive colors including yellow, red, blue and black. The step of coating is performed through a coating machine The drying step is preformed by a blowing or baking machine Furthermore, the mentioned white ink layer 127 is a white paint. The adhesive layer 129 is a heat transfer-printing glue conventionally for printing.

Reference is made to FIG. 2 showing a schematic diagram of one embodiment of the plateless transfer printing film in accordance with the instant disclosure. The shown plateless transfer printing film 1 is made of a slice or a roll of flexible materials. The substrate 10 may have 250 meshes for example. The unit of mesh is strip(s) per inch.

In one embodiment, the plateless transfer printing film 1 is manufactured above the substrate 10, on which a coating machine or a printer is utilized to form the de-bonding Layer 121. Next, the pattern layer 125 is formed on the de-bonding layer 121 by utilizing the coating machine or the printer. Alternatively, the transparent protective layer 123 may be firstly formed and then the pattern layer 125 is printed.

It is noted that the de-bonding layer 121 has higher number of meshes and is difficult to be permeated by the ink or paint of the pattern layer 125. For example, the number of meshes is at least 400 or higher. These meshes can be evenly colored. The white ink layer 127 is then coated or printed on the pattern layer 125. This white ink layer 127 may have around 300 meshes for eliminating the drawback of no white ink is output from the printer. Therefore, the white ink layer 127 is provided to increase the contrast of the pattern layer 125.

Next, this white ink layer 127 is coated with the adhesive layer 129 by the coating machine, or printed by the printer. The adhesive layer 129 is as a molten form under an appropriate temperature. For example, the adhesive layer 129 obtains a better adhesive property at 75 to 120 degrees centigrade, but low under normal temperature. So that, this property allows the plateless transfer printing film 1 to be adhesive as heating, and to be packaged as a roll under the normal temperature.

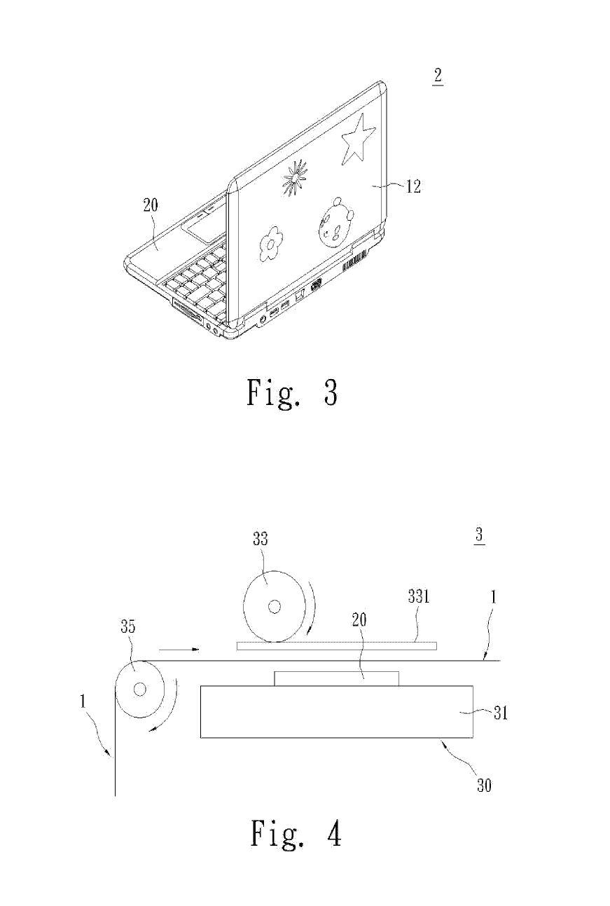

Further reference is made to FIG. 3 showing a schematic diagram of one embodiment of an electronic device with colored pattern, especially the full-color pattern, in accordance with the instant disclosure. The electronic device 2 mainly includes an electronic device body 20 and a transferring layer 12. The pattern layer 125 of the transferring layer 12 is a customized pattern as required, and transferred onto the replaceable casing of a notebook computer, and it also provides the unique appearance and false-proofing for the notebook computer. For successfully performing transfer printing on the body 20 with the film 1, the material of the adhesive layer 129 is required to fit with the material of electronic device body 20 and compatible with the surface material of the electronic device body 20. In particular, the material of adhesive layer 129 may be Polyester, Epoxy, or their composition. The material of electronic device body 20 may be metal or plastics whose adhesive layer 129 has good adhesive under a specific temperature.

The above described requirements of materials for every component allow the adhesive layer 129 to be closely adhered to the surface of electronic device body 20. Since the temperature will not reach the melting point of the electronic device body 20, the body 20 may not be damaged. In one embodiment, the adhesive layer 129 may have lower melting point, around 75 to 100 degrees, so the transfer printing is processed under a lower temperature. Therefore, the electronic device body 20 can be prevented from melt or damage. In the process, if the temperature is cooled down to a lower temperature after finishing the heating process, around 40 degrees, the de-bonding layer 121 still stays cool or be liquid state. In the meantime, the transferring layer 12 can be evenly de-bonded from the substrate 10. In which, the transferring layer 12 does or does not include a transparent protective layer 123. If the transferring layer 12 does not include the transparent protective layer 123, a layer of anti-dissolvent agent transparent ink is coated upon the pattern layer 125 to be a protective layer 123 after the substrate 10 is de-bonded from the transferring layer 12. This protective layer 123 is used to protect the pattern layer 125 from damage by the chemical solvent or any physical abrasion.

In one further embodiment, the transferring layer 12 does not include the adhesive layer 129. However, as heating, the material of the electronic device body 20 or its color base of surface may have adhesive to adhere to the pattern layer 125.

Next reference is made to FIG. 4 showing a schematic diagram of the embodiment of the plateless transfer printing device. The plateless transfer printing device 3 includes a plateless transfer printing film 1 and a transferring machine 30. The transferring machine 30 includes a roller 33, a fixed base 31, and a transfer member 35. The fixed base 31 is used to fix the electronic device body 20. The roller 33 is fit with the appearance of the body 20. The position of roller 33 may be raised or descended. In an exemplary embodiment, a plurality of rollers 33 is reconfigurable to have different or the same radiuses. Therefore, the plateless transfer printing film 1 can be evenly molded with electronic device body 20. The transfer member 35 is used to evenly spread the plateless transfer printing film 1 over the body 20.

In particular, the transfer member 35 may be a rotatable axis or a roller. Before the electronic device body 20 is covered with the plateless transfer printing film 1, the film 1 may be heated by a heater (not shown) to a specific temperature, around 75 to 100 degrees. This temperature serves the plateless transfer printing film 1 to be adhesive. The heater may be an optical source such as a laser device. While the plateless transfer printing film 1 is positioned on the body 20 and to be transferred onto the surface. When the roller 33 is embossed onto the plateless transfer printing film 1, the film 1 is evenly transferred on the body 20 without blisters.

According to one embodiment in accordance with the disclosure, the transferring machine 30 further includes an exhauster (not shown) used for drawing interior of the machine 30 into a vacuum. The vacuum status can assure there is no blister existed between the plateless transfer printing film 1 and the electronic device body 20. Exemplarily, the roller 33 has a heating source (not shown) which has temperature around 75 to 100 degrees. As the roller 33 contacts with the plateless transfer printing film 1, the roller 33 heats the plateless transfer printing film 1 at the same time. This heating process makes sure that the plateless transfer printing film 1 is closely adhered to the electronic device body 20.

In another embodiment, the transferring machine 30 has a high-temperature blower (not shown). While the mentioned roller 33 embosses the plateless transfer printing film, a silicone layer 331 covers the plateless transfer printing film 1. In which, the blower pressures the silicone layer 331 with high temperature air which performs an indirect pressure upon the plateless transfer printing film 1. Meanwhile, if the surface of electronic device body 20 is uneven or with vertical angle, the silicone layer 331 is helpful to produce the uniform pressure on the film 1. Therefore, the plateless transfer printing film 1 may be closely sealed with the body 20 as the requirement of high-quality transfer printing.

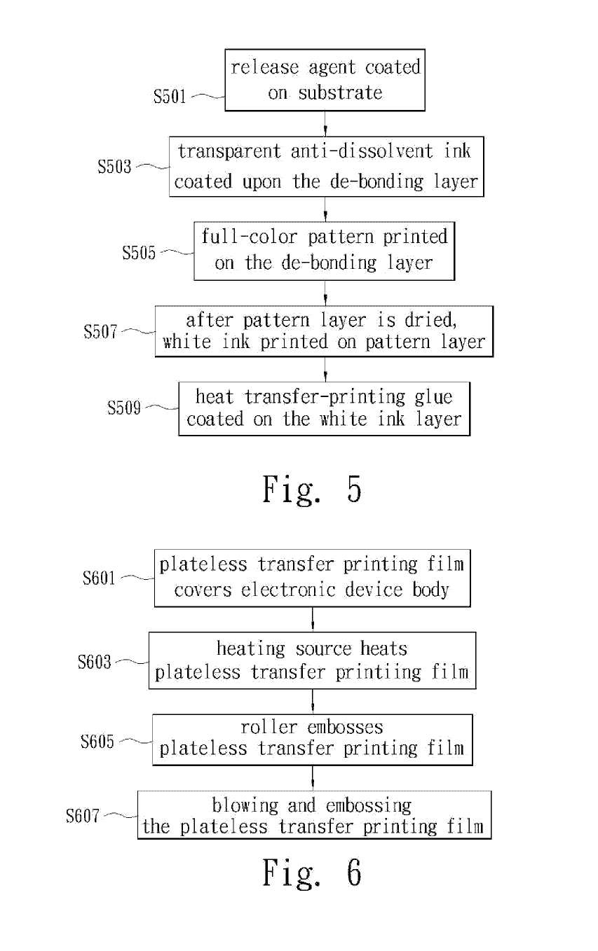

FIG. 5 depicts a work flow of the method of manufacturing the plateless transfer printing film in accordance with the disclosure. In a beginning step of the method, a plastic film or paper is prepared to be a substrate 10. In step S501, a de-bonding layer 121 is formed by coating a release agent on the substrate 10 by a coating machine After the de-bonding layer 121 is dried, a transparent anti-dissolvent ink is coated upon the de-bonding layer 121 for forming a transparent protective layer 123 (step S503). Next, a pattern layer 125 is formed as the laser printer or inkjet printer used to output a colored pattern, especially the full-color pattern (step S505) upon the transparent protective layer 123. Exemplarily, the pattern layer 125 is formed by repeating the printing for many times. Since the pattern layer 125 stays dry, the white ink is then printed on the pattern layer 125 and a white ink layer 127 is formed (step S507). This white ink layer 127 is used as a color base. After the white ink layer 127 is dried, a heat transfer-printing glue is coated on the white ink layer 127 as an adhesive layer 129 (step S509).

FIG. 6 shows one more flow chart illustrating the method for manufacturing the electronic device with colored pattern in accordance with the instant disclosure. In the beginning, the plateless transfer printing film 1 is prepared. This film 1 can evenly cover over the electronic device body 20 through a transfer member 35 of the transferring machine 30 (step S601). Next, a heating source such as a laser machine is introduced into providing the heat to the plateless transfer printing film 1 (step S603). The temperature to process the heating is around 75 to 100 degrees. In step S605, the roller 33 is used to emboss the plateless transfer printing film 1 (step S605). In one embodiment of the instant disclosure, this roller 33 is equipped with a heating source which is used to heat the film 1 while embossing the plateless transfer printing film 1. The transferring machine 30 may include a plurality of rollers 33. Next, the method introduces the air with 75 to 100 degrees into blowing and embossing the plateless transfer printing film 1 (step S607). In one preferred embodiment, the plateless transfer printing film 1 may be covered with a silicone layer 331. The high temperature air is blown to pressure the silicone layer 331, and evenly onto the plateless transfer printing film 1 indirectly.

To sum up the above descriptions related to the exemplary embodiments, the blowing and pressuring processes are particularly performed upon the plateless transfer printing film transferred onto the electronic device body. Therefore, the uneven surface or the vertical angle may be performed by the processes of blowing and pressuring. Thus the plateless transfer printing device may be used to minimize the effect of blisters between the transfer printing film and the electronic device body.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A plateless transfer printing film, comprising:
a substrate; and
a transferring layer, formed on the substrate, comprising:
a de-bonding layer, formed on the substrate, providing a releasing option between the substrate and the transferring layer;
a pattern layer, formed on the de-bonding Layer 1, having colored picture, character, symbol or number;
a white ink layer, formed on the pattern layer; and
an adhesive layer, formed on the white ink layer, allowing the plateless transfer printing film to be adhesive.

2. The film of claim 1, wherein the substrate is made of plastics or paper.

3. The film of claim 1, wherein the pattern layer is output by an ink-jet printer or a laser printer.

4. The film of claim 1, wherein the de-bonding layer is made by a heat-fusing type, a heat-curing type or a semi-hardening type release agent.

5. The film of claim 1, wherein the adhesive layer is made of a heat-transfer printing glue.

6. The film of claim 1, further comprising a transparent protective layer formed between the de-bonding layer and the pattern layer.

7. A method for manufacturing an electronic device with colored pattern, comprising:
preparing a plateless transfer printing film as recited in claim 1;
covering the plateless transfer printing film over body of an electronic device;
performing a roller-embossing on the plateless transfer printing film by a roller; and
embossing the plateless transfer printing film.

8. The method of claim 7, wherein the step of preparing the plateless transfer printing film comprises:
coating a release agent on a substrate to form a de-bonding layer;
printing a colored pattern on the de-bonding layer to form a pattern layer when the de-bonding layer is dried;
printing a white ink on the pattern layer to form a white ink layer as the pattern layer is dried; and
coating the heat-transfer printing glue on the white ink layer to form an adhesive layer when the white ink layer is dried.

9. The method of claim 8, wherein the step of performing roller-embossing on the plateless transfer printing film is to heat the plateless transfer printing film with an optical-energy heater.

10. The method of claim 8, wherein the step of embossing the plateless transfer printing film further include a step of covering a silicon film thereon.

11. The method of claim 8, wherein the step of embossing the plateless transfer printing film is to perform a blowing and embossing step.

12. The method of claim 8, further comprising a step of separating the substrate and the transferring layer, and coating a transparent protective layer thereon.

13. An electronic device with colored pattern, comprising:
an electronic device body;
an adhesive layer, formed on the body of the electronic device;
a white ink layer, formed on the adhesive layer; and
a pattern layer, formed on the white ink layer, having a colored picture, character, symbol or number.

14. The electronic device of claim 13, wherein the electronic device body is a replaceable casing.

15. The electronic device of claim 13, wherein the material of the adhesive layer and the material of the electronic device body are compatible.

16. The electronic device of claim 13, wherein the adhesive layer is a heat transfer-printing glue.

17. The electronic device of claim 13, wherein the pattern layer is formed as colored picture or character output by a printer.

18. The electronic device of claim 13, wherein the pattern layer is formed by a plurality of times of printing and baking.

19. The electronic device of claim 13, further comprising a transparent protective layer formed on the pattern layer.

20. The electronic device of claim 19, wherein the transparent protective layer is made of transparent anti-dissolvent ink, transparent acrylic glue, or transparent hot-melt glue.
